(19) United States
(12) Patent Application Publication
(10) Pub. No.: US 2002/0172883 A1
(43) Pub. Date: Nov. 21, 2002

(54) Replenishment toner

(76) Inventors: Norio Kubo, Osaka (JP); Akinori Koyama, Osaka (JP)

Correspondence Address: SMITH, GAMBRELL & RUSSELL, LLP, 1850 M STREET, N.W., SUITE 800, WASHINGTON, DC, 20036, US

(21) Appl. No.: 10/059,157

(22) Filed: Jan. 31, 2002

(30) Foreign Application Priority Data
Mar. 30, 2001 (JP) 2001-100442

(51) Int. Cl. G03G 9/08

(52) U.S. Cl. 430/110.4

(57) ABSTRACT

In a replenishment toner for use in an image forming apparatus that detects the toner concentration in a two-component developer by the use of a magnetic permeability detecting means, the percentage by volume of toner particles with particle diameters of 5.04 μm or smaller contained in the replenishment toner is in the range from 1.5 to 3.5 times the percentage by volume of such toner particles contained in the initial toner loaded initially in the image forming apparatus. This makes it possible to minimize the variation in magnetic permeability even when the toner is charged with an increasingly large amount of electric charge as image formation proceeds, and thereby maintain the toner concentration in the developer properly. By limiting the median particle diameter on a volume basis of the replenishment toner in the range from 8.0 to 12.0 μm, it is possible to further reduce the variation in magnetic permeability resulting from the variation in the amount of electric charge with which the toner is charged.

### BACKGROUND OF THE INVENTION

1. Field of the Invention

The present invention relates to a replenishment toner for a two-component developer, and more specifically to a replenishment toner for a two-component developer for use in an image forming apparatus exploiting so-called electrophotography, such as an electrostatic copier or laser beam printer.

2. Description of the Prior Art

In a two-component developer composed of a toner and a carrier, as the toner is consumed in development, the concentration of the toner in the developer varies. Therefore, to keep the toner concentration constant, it is necessary to replenish the developer with the same amount of toner as has been consumed in development. To detect the toner concentration in a developer, a method based on the detection of magnetic permeability has been widely used. In this method, the magnetic permeability of the carrier, which is magnetic particles, is detected with a magnetic permeability detecting means, and the variation of the detected magnetic permeability is referred to as an index to the variation of the toner concentration.

Specifically, when a two-component developer is passed inside a coil (magnetic field) provided in a resonance circuit, the inductance of the coil varies according to the amount of carrier, which is magnetic particles, passed therethrough. This variation in the inductance is recognized as variation in the frequency of the resonance circuit, which is then subjected to f/V conversion so as to be converted into the magnetic permeability (V). When there is plenty of toner, the amount of carrier per unit volume is small, and therefore the magnetic permeability is low; by contrast, when the toner becomes scarce, the amount of carrier per unit volume is large, and therefore the magnetic permeability is high. In this way, from the variation in the magnetic permeability, it is possible to detect the toner concentration in the developer.

When image formation is continued by using, as a replenishment toner, the same toner as the initial toner, the toner is charged with an increasingly large amount of electric charge. As the toner is charged with an increasingly large amount of electric charge, the Coulomb force (repulsive force) acting between the toner particles increases, bringing the toner particles farther apart from one another. This also brings the carrier particles farther apart from one another, and thereby causes the magnetic permeability to lower. As a result, although the actual toner concentration is low, the magnetic permeability is detected as apparently proper or high, and thus no replenishment of the toner takes place. Eventually, the actual toner concentration falls below the proper range, resulting in problems such as low image density and carrier scattering.

### SUMMARY OF THE INVENTION

An object of the present invention is to provide a replenishment toner that minimizes the variation of magnetic permeability even when a toner in a two-component carrier is charged with an increasingly large amount of electric charge as image formation proceeds and that thereby helps maintain the toner concentration in the developer properly.

To achieve the above object, according to the present invention, in a replenishment toner for use in an image forming apparatus that detects the toner concentration in a two-component developer by the use of a magnetic permeability detecting means, the percentage by volume of toner particles with particle diameters of 5.04 μm or smaller contained in the replenishment toner is in the range from 1.5 to 3.5 times the percentage by volume of such toner particles contained in the initial toner loaded initially in the image forming apparatus. With this replenishment toner, it is possible to minimize the variation in magnetic permeability even when the toner in the two-component developer is charged with an increasingly large amount of electric charge as image formation proceeds, and thereby maintain the toner concentration in the developer properly. It is to be noted that, in the present specification, the initial toner denotes the toner that has been loaded in the image forming apparatus from the beginning.

Moreover, by limiting the median particle diameter on a volume basis (hereinafter referred to simply as the “median particle diameter” also) of the replenishment toner in the range from 8.0 to 12.0 μm, it is possible to further reduce the variation in magnetic permeability resulting from the variation in the amount of toner electric charge.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a diagram showing examples of the electric charge distribution in a replenish toner according to the invention and in a conventional toner; and

FIG. 2 is a diagram showing the variation with time of the toner concentration.

### DESCRIPTION OF THE PREFERRED EMBODIMENTS

As a result of an intensive study made to examine whether it is possible or not to reduce the variation in magnetic permeability even when a toner is charged with an increasingly large amount of electric charge, the inventors of the present invention have found out that, by increasing the proportion of fine particle toner contained in the toner, it is possible to minimize the variation in magnetic permeability resulting from the variation in the amount of toner electric charge, which finding has led to the present invention.

As described earlier, as a toner is charged with an increasingly large amount of electric charge, it exhibits lower and lower magnetic permeability because, as the toner is charged with an increasingly large amount of electric charge, the Coulomb force acting as a repulsive force between the toner particles increases and thus brings the toner particles farther apart from one another. On the other hand, the smaller the toner particle diameter, the smaller the amount of electric charge (μC) with which each toner particle is charged. Thus, the smaller the toner particle diameter, the weaker the Coulomb force acting between the toner particles. Exploiting this fact, the inventors of the present invention have succeeded in minimizing the increase of the Coulomb force by increasing the proportion of fine particle toner in a toner so as to make the distribution of electric charge broader even when the toner as a whole is charged with an increasingly large amount of electric charge.

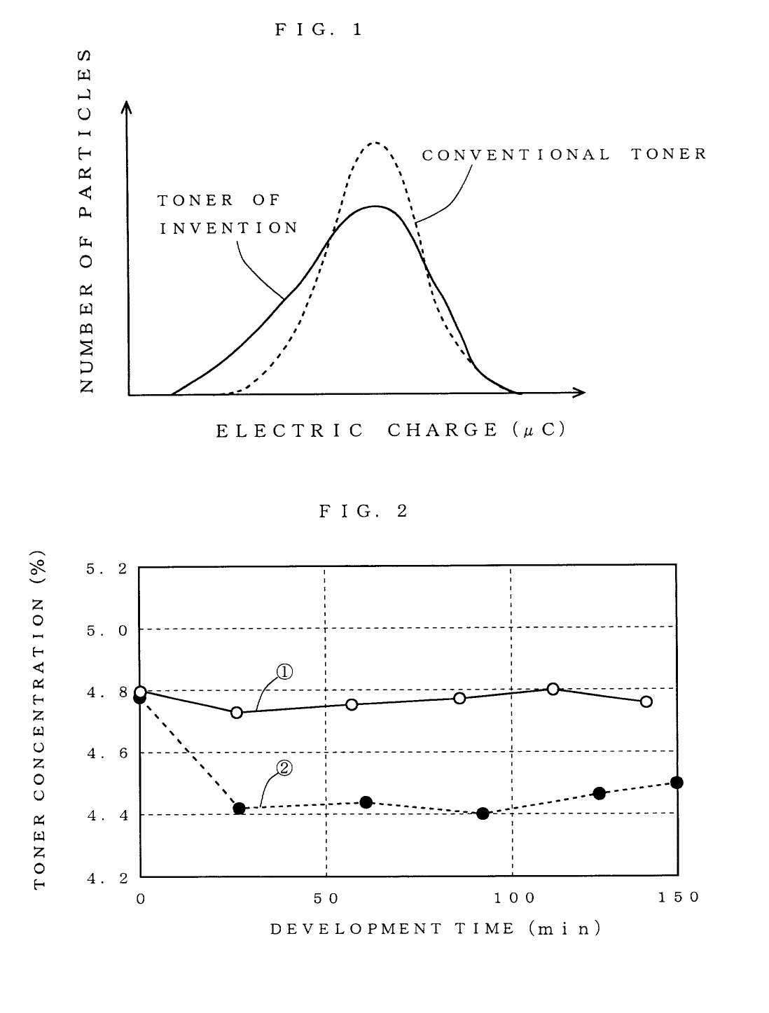

FIG. 1 shows examples of the electric charge distribution in toners. More specifically, FIG. 1 shows the electric charge distribution observed in a conventional toner and in a replenishment toner according to the invention after the development of images on a predetermined number of sheets of paper. In this figure, along the vertical axis is taken the number of toner particles, and along the horizontal axis is taken the amount of electric charge (μC) with which the individual toner particles are charged. As will be understood from this figure, as compared with the conventional toner, the replenishment toner according to the invention contains a larger proportion of fine particles charged with less electric charge, and thus exhibits a flatter electric charge distribution. As a result, even when the toner as a whole is charged with the same amount of electric charge as the conventional one, the Coulomb force acting between the toner particles is weaker, and thus the carrier particles can be held closer together. This permits accurate detection of the toner concentration by the use of a magnetic permeability detecting means.

FIG. 2 shows the variation with time of the toner concentration as actually observed in a developer unit. Here, the development of images was performed using, as the initial toner, a toner with an average particle diameter of 9.7 μm containing 0.6% by volume of particles with particle diameters of 5.04 μm or smaller and, as the replenishment toner, either (1) a toner with an average particle diameter of 9.7 μm containing 1.0% by volume (i.e. 1.7 times as much as in the initial toner) of particles with particle diameters of 5.04 μm or smaller or (2) the same toner as the initial toner.

FIG. 2 shows the following. When the same toner as the initial toner was used as the replenishment toner (indicated by a broken line in the figure), the toner concentration, initially about 4.9%, dropped to about 4.4% in 30 min after the developer unit started being operated, and then lingered at about 4.4% thereafter. By contrast, when the toner according to the invention was used as the replenishment toner (indicated by a solid line in the figure), the toner concentration remained in the range between 4.7 and 4.8% from the start, exhibiting almost no change.

As will be described later, as a result of experiments conducted with varying percentages by volume of particles with particle diameters of 5.04 μm or smaller contained in the replenishment toner, it has been found that the percentage by volume of particles with particle diameters of 5.04 μm or smaller contained in the replenishment toner needs to be 1.5 to 3.5 times that contained in the initial toner. If the replenishment toner contains less than 1.5 times the percentage by volume of particles with particle diameters of 5.04 μm or smaller contained in the initial toner, it is not possible to alleviate the lowering of magnetic permeability sufficiently, and thus it is not possible to maintain the desired toner concentration. On the other hand, if the replenishment toner contains more than 3.5 times the percentage by volume of such particles contained in the initial toner, the toner scatters. A further preferred range is from 2.0 to 2.5 times. The diameter of toner particles was measured using a “Coulter counter.”

The percentage by volume of particles with particle diameters of 5.04 μm or smaller contained in a toner can be controlled by a conventionally known method. For example, it can be controlled by controlling the degree of classification in the classifying process in the course of the manufacture of the toner, or by mixing the toner with fine toner particles that have been prepared separately.

A replenishment toner according to the invention can be manufactured by a process that itself is conventionally known, such as crushing-and-classifying, melt granulation, spray granulation, or suspension/emulsification polymerization. Among these, from the viewpoint of manufacturing equipment and productivity, a preferred process is crushing-and-classifying. Crushing-and-classifying is performed in the following manner. First, the toner composition containing a binder resin and a colorant, with a charge control agent and a mold release agent added thereto as required, is premixed in a Henschel mixer or a V-blender, and is then melt and kneaded in a melting-kneading machine such as a twin-screw extruder. The toner composition thus melted and kneaded is cooled, is then subjected to coarse/fine crushing, and is then, as required, classified to obtain toner particles having the desired particle size distribution. As required, the surfaces of the toner particles are treated with a surface treatment agent to obtain the toner according to the present invention.

To further reduce the variation in magnetic permeability resulting from the variation in the amount of toner electric charge, and to obtain images with higher quality, the median particle diameter of a replenishment toner according to the invention is preferably in the range from 0.8 to 12.0 μm, and further preferably equal to the median particle diameter of the initial toner, from the viewpoint of harmonization with the initial toner. The composition of the replenishment toner is preferably of the same kind as that of the initial toner, and further preferably identical with that of the initial toner.

There are no particular restrictions on the type of the aforementioned binder resin, examples of which include styrene-acrylic resin and polyester resin. Needless to say, as required, these types of resin may be used in combination with another type of resin.

Examples of the monomers that are used as the base of the styrene-acrylic resin include: derivatives of styrene such as styrene, α-methylstyrene, p-methylstyrene, p-t-butylstyrene, p-chlorstyrene, and hydroxystyrene; and esters of (meth)acrylic acid such as methacrylic acid, methyl (meth)acrylate, ethyl (meth)acrylate propyl (meth)acrylate, butyl (meth)acrylate, glycidyl (meth)acrylate, methoxyethyl (meth)acrylate, propoxyethyl (meth)acrylate, methoxydiethylene glycol (meth)acrylate, ethoxydiethylene glycol (meth)acrylate, benzil (meth)acrylate, cyclohexyl (meth)acrylate, tetrahydrofurfuryl (meth)acrylate, (meth)acrylonitrile, (meth)acrylamide, N-methylol (meth)acrylamide, ethylene glycol di(meth)acrylate, 1,3-butylene glycol di(meth)acrylate, 1,4-butanediol di(meth)acrylate, and trimethylol ethane tri(meth)acrylate.

A mixture of some of these monomers is made into the binder resin used in the present invention by polymerizing the mixture by an appropriate process such as solution polymerization, block polymerization, emulsion polymerization, or suspension polymerization. In the polymerization process here, any conventionally known polymerization initiator can be used, examples of which include: acetyl peroxide, decanoyl peroxide, lauroyl peroxide, benzoyl peroxide, azobisisobutyronitrile, 2,2′-azobis-2,4-dimethylvaleronitrile, and 2,2′-azobis-4-methoxy-2,4-dimethylvaleronitrile. Preferably 0.1 to 15% by weight of one of these polymerization initiators is added to the total weight of the monomers.

The polyester resin is produced mainly through condensation polymerization of a polycarboxylic acid and a polyhydric alcohol. Examples of the polycarboxylic acid include: aromatic polycarboxylic acids such as phthalic acid, isophthalic acid, terephthalic acid, succinic acid, 1,2,4-benzenetricarboxylic acid, 2,5,7-naphthalenetricarboxylic acid, 1,2,4-naphthalenetricarboxylic acid, and pyromellitic acid; aliphatic dicarboxylic acids such as maleic acid, fumaric acid, succinic acid, adipic acid, sebacic acid, malonic acid, azelaic acid, mesaconic acid, citraconic acid, and glutaconic acid; alicyclic dicarboxylic acids such as cyclohexane dicarboxylic acid and cyclohexenedicarboxylic acid; and anhydrides and lower alkyl esters of these carboxylic acids. These are used singly or as a mixture of two or more of them.

Here, the content of components with three or more carboxyl or hydroxy groups depends on the degree of cross-linking, and therefore the desired degree of cross-linking can be achieved by controlling the amount of such components added. In general, a preferred content of components with three or more carboxyl or hydroxy groups is 15 mol % or lower.

On the other hand, examples of the polyhydric alcohol used in the polyester resin include: alkylene glycols such as ethylene glycol, 1,2-propylene glycol, 1,3-propylene glycol, 1,4-butanediol, 1,4-butenediol, neopentyl glycol, 1,5-pentane glycol, and 1,6-hexane glycol; alkylene ether glycols such as diethylene glycol, triethylene glycol, dipropylene glycol, polyethylene glycol, polypropylene glycol, and polytetramethylene glycol; alicyclic polyhydric alcohols such as 1,4-cyclohexame dimethanol and hydrogenated bisphenol A; and bisphenols such as bisphenol A, bisphenol F, and bisphenol S, and alkylene oxides of such bisphenols. These are used singly or as a mixture of two or more of them.

As required, monocarboxylic acids and monohydric alcohols may be used for the purpose of adjusting the molecular weight and controlling the reaction. Examples of monocarboxylic acids include benzoic acid, p-hydroxybenzoic acid, toluenecarboxylic acid, salicylic acid, acetic acid, propionic acid, and stearic acid. Examples of monohydric alcohols include benzil alcohol, toluene-4-methanol, and cyclohexane methanol.

The polyester resin used in the present invention is produced from these materials by an ordinary process. For example, the alcohol and acid components in predetermined proportions are put in a reaction vessel, and then, with an inert gas such as nitrogen kept blown into them, their reaction is started in the presence of a catalyst at a temperature of 150 to 190° C. The low-molecular-weight compounds that are produced as by-products are continuously driven out of the reaction system. Thereafter, the reaction temperature is raised to 210 to 250° C. to prompt the reaction and obtain the desired polyester resin. The reaction is possible under any of normal, reduced, or increased pressure. Preferably, once the reaction rate has reached 50 to 90%, the reaction is continued under reduced pressure of 200 mmHg or lower.

Examples of the catalyst mentioned above include: metals such as tin, titanium antimony, manganese, nickel, zinc, lead, iron, magnesium, calcium, or germanium; and compounds of these metals.

It is preferable that the binder resin used in the present invention have a glass transition point in the range from 45 to 90° C. With a glass transition point below 45° C., the binder resin may gather together inside a toner cartridge or a developer unit. On the other hand, with a glass transition point over 90° C., the toner may not fuse satisfactorily onto a transfer material such as paper.

In the present invention, the following substances can be used as the colorant. Examples of black pigments include: carbon black such as acetylene black, lamp black, and aniline black. Examples of yellow pigments include: chrome yellow, zinc yellow, cadmium yellow, yellow iron oxide, mineral fast yellow, nickel-titanium yellow, naphthol yellow S, Hansa yellow G, Hansa yellow 10G, benzidine yellow G, benzidine yellow GR, quinoline yellow lake, permanent yellow NCG, and tartrazine lake. Examples of orange pigments include: chrome orange, molybdate orange, permanent orange GTR, pyrazolone orange, vulcan orange, indanthrene brilliant orange RK, benzidine orange G, and indanthrene brilliant orange GK. Examples of red pigments include: red iron oxide, cadmium red, minium (red lead), mercury cadmium sulfide, permanent red 4R, lithol red, pyrazolone red, watching red calcium salt, lake red D, brilliant carmin 6B, eosin lake, rhodamine lake B, alizarin lake, and brilliant carmin 3B. Examples of violet pigments include: manganese violet, fast violet B, and methyl violet lake. Examples of blue pigments include: iron blue, cobalt blue, alkali blue lake, Victoria blue lake, phthalocyanine blue, metal-free phthalocyanine blue, partially chlorinated phthalocyanine blue, fast sky blue, and indanthrene blue BC. Examples of green pigments include: chrome green, chromium oxide, pigment green B, malachite green lake, and final yellow green G. Examples of white pigments include: zinc white, titanium oxide, antimony white, zinc sulfide, baryta powder, barium carbonate, clay, silica, white carbon, talc, and alumina white. These colorants may be used singly or as a mixture of two or more of them.

Preferably 0.1 to 20 parts by weight, and particularly preferably 1 to 15 parts by weight, of the colorant(s) in total is added to 100 parts by weight of the binder resin.

Among the colorants mentioned above, a preferred one in development using a black color is carbon black. From the viewpoint of preventing an increase in the amount of electric charge resulting from the lowing of electrical conductivity, among various types of carbon black, further preferred types are those having a specific surface area of 120 to 460 m²/g and a DBP oil absorption rate of 50 to 150 ml/100 g. From the viewpoint of color tone, preferably 1 to 3 parts by weight of such carbon black is added to 100 parts by weight of the binder resin. Here, the specific surface area is measured by a specific surface area measurement method (BET method) based on absorption of nitrogen gas at low temperature, and the DBP oil absorption rate denotes the amount of dibutyl phthalate required to fill gaps in a given amount of carbon black.

As the charge control agent can be used any conventionally known type, examples of which include: as charge control agents that tend to be positively charged, nigrosine dyes, nigrosine dyes denatured with a fatty acid, nigrosine dyes denatured with a fatty acid containing a carboxyl group, quaternary ammonium salts, amine-based compounds, and organic metallic compounds; and, as charge control agents that tend to be negatively charged, metallic complexes of a hydroxycarboxylic acid, metallic complexes of an azo compound, metal complex dyes, and salicylic acid derivatives.

As the mold release agent can be used various types of wax or low-molecular-weight olefin resin. Examples of wax include: esters of a fatty acid with a polyhydric alcohol; esters of a fatty acid with a higher alcohol; amides of an alkylenebis fatty acid; and natural waxes. Examples of low-molecular-weight olefin resin include: polypropylene, polyethylene, and propylene-ethylene copolymer with a number-average molecular weight in the range from 1,000 to 10,000, in particular in the range from 2,000 to 6,000. Among these, a particularly suitable type is polypropylene.

As the surface treatment agent can be used any substance that improves the charge controllability and flowability of the toner, examples of which including: inorganic fine particle powder such as silica, alumina, titanium oxide, zinc oxide, magnesium oxide, calcium carbonate, and magnetic power; organic fine particle powder such as polymethyl methacrylate; and metallic salts of a fatty acid such as zinc stearate. These are used singly or as a mixture of two or more of them. The surface treatment agent is mixed with the toner, for example, in a Henschel mixer, V-blender, tumbler mixer, or hybridizer.

Examples of the carrier include: magnetic metals such as iron, nickel, and cobalt, alloys of these metals, and alloys of these metals containing a rare-earth element; iron-based oxides such as hematite, magnetite, manganese-zinc ferrites, nickel-zinc ferrites, manganese-magnesium ferrites, soft ferrites such as lithium ferrites, and copper-zing ferrites; magnetic particles produced by subjecting a magnetic material, such as a mixture of some of those mentioned above, to sintering and atomizing or the like; and particles obtained by coating the surfaces of such magnetic particles with a resin. As the carrier, it is also possible to use a resin having a magnetic material dispersed therein. In this case, as the magnetic material can be used one of the magnetic materials mentioned above, and as the binder resin can be used, for example, vinyl-based resin, polyester-based resin, epoxy resin, phenol resin, urea resin, polyurethane resin, polyimide resin, cellulose resin, polyether resin, or a mixture of some of these.

A preferred particle diameter of the carrier is 30 to 200 μm, and further preferably 50 to 150 μm, as observed under an electron microscope as generally practiced. A preferred range of the apparent density of the carrier is from 2.4 to 3.0 g/cm³, though subject to variation according to the composition, the surface structure, and the like of the magnetic material when one is used as the main ingredient.

In a two-component developer composed of the toner and carrier described above, a preferred toner concentration is 1 to 10% by weight, and further preferably 1 to 7% by weight. With a toner concentration below 1% by weight, the produced image has too low density. On the other hand, with a toner concentration over 10% by weight, the toner may scatter inside a developer unit, making the inside of the image forming apparatus dirty and causing the toner to attach to the background portion of sheets of transfer paper.

There are no particular restrictions on the type of the initial toner contained in the developer that is replenished with a replenishment toner according to the invention, a preferred type being a toner containing about 0.5 to 1.5% by volume, and further preferably 0.6 to 1.0% by volume, of particles with particle diameters of 5.04 μm or smaller.

### EXAMPLES

Preparation of Toners and Two-Component Developers

In a Henschel mixer, 100 parts by weight of styrene-acrylic resin, as a binder resin, containing a mold release agent (a paraffin wax and a hydrocarbon wax), 12 parts by weight of carbon black as a colorant, 1 part by weight of a charge control agent, and 1.5 parts by weight of magnetite as magnetic powder were put and then blended. The mixture was then melted and kneaded in a twin-screw extruder, and was then cooled in a drum flaker. The mixture was then subjected to coarse crushing on a hammer mill and then to fine crushing on a jet mill, and was then classified with a pneumatic classifier. In this way, five types of toner particles were prepared that all had a median particle diameter of 9.7 μm but that respectively contained 0.6, 0.8, 1.0, 2.0, and 2.2% by volume of particles with particle diameters of 5.04 μm or smaller.

To 100 parts by weight of each of these types of toner particles, 0.5 part by weight of hydrophobic silica and 0.05 part by weight of titanium oxide were added as a surface treatment agent. The mixture was then violently agitated and mixed in a Henschel mixer to obtain a toner.

In cases where this toner was used as an initial toner, the toner was blended with a ferrite carrier having an average particle diameter of 80 μm with the surfaces of its particles coated with silicone resin in such a way that the toner concentration was 5% by weight. The mixture was then agitated and mixed to obtain a two-component developer.

Printing Tests

Each of the two-component developers prepared as described above was loaded in the developer unit of an electrophotographic copier manufactured by Kyocera Mita Corporation, Japan (sold under the trade name “Creage 7350”) and equipped with a magnetic permeability sensor (a toner sensor (magnetic sensor), model No. TS0524LB-C, manufactured by TDK Corp., Japan, with the following specifications: rated input voltage DC 24 V±10%, working temperature 0 to 60° C., working humidity 10 to 85% RH). Moreover, one of the toners prepared as described above was loaded in the replenishment hopper unit of the same electrophotographic copier. Then, bulk copying was performed on 50,000 sheets of paper, and thereafter the toner concentration in the developer unit was measured. The toner concentration was calculated from the difference in the amount of carbon in the developer unit as measured using a carbon analyzer (model EMIA-110 manufactured by Horiba Ltd., Japan). The results of all the experiments conducted are shown in Table 1.

Table 1 shows the following. In Experiments Nos. 1 and 2, where the ratio (Y/X) of the percentage by volume of particles with particle diameters of 5.04 μm or smaller contained in the replenishment toner to that contained in the initial toner was 1.7 and 3.3 respectively, the toner concentration after bulk copying on 50,000 sheets of paper was 4.6% and 5.2%, and was thus maintained satisfactorily close to the specified toner concentration (5%). By contrast, in Experiment No. 3, where the ratio (Y/X) was 0.6, the toner concentration after bulk copying dropped to 2.6%, i.e. about half the specified toner concentration, causing low image density and carrier scattering. In Experiment 4, where the ratio (Y/X) was 1.0, i.e. the same toner as the initial toner was used as the replenishment toner, and in Experiment 5, where the ratio (Y/X) was 1.3, the toner concentration after bulk copying dropped to 3.4% and 3.8%, out of the permissible range around the specified toner concentration. In Experiment 6, where the ratio (Y/X) was 3.7, the toner concentration after bulk copying rose to 6.0%, i.e. higher than the specified toner concentration, causing toner scattering.

TABLE 1

| | | % by Volume | | | |
|---|---|---|---|---|---|
| | % by Volume | [X] of Particles | | Toner | |
| | [X] of Particles | 5.04 μm or | | Concen- | |
| | 5.04 μm or | Smaller in | | tration (%) | |
| | or Smaller in | Replenishment | | After Bulk | |
| No. | Initial Toner | Toner | Y/X | Copying | Evaluation |
| 1 | 0.6 | 1.0 | 1.7 | 4.6 | Good |
| 2 | 0.6 | 2.0 | 3.3 | 5.2 | Good |
| 3 | 1.0 | 0.6 | 0.6 | 2.6 | Low Image |
| | | | | | Density, |
| | | | | | Toner |
| | | | | | Scattering |
| 4 | 0.6 | 0.6 | 1.0 | 3.4 | Low Image |
| | | | | | Density |
| 5 | 0.6 | 0.8 | 1.3 | 3.8 | Low Image |
| | | | | | Density |
| 6 | 0.6 | 2.2 | 3.7 | 6.0 | Toner |
| | | | | | Scattering |

What is claimed is:

1. A replenishment toner for use in an image forming apparatus that detects a toner concentration in a two-component developer by use of a magnetic permeability detecting means,
wherein a percentage by volume of toner particles with particle diameters of 5.04 μm or smaller contained in the replenishment toner is in a range from 1.5 to 3.5 times a percentage by volume of such toner particles contained in an initial toner loaded initially in the image forming apparatus.

2. A replenishment toner as claimed in claim 1,
wherein a median particle diameter on a volume basis of the replenishment toner is in a range from 8.0 to 12.0 μm.

3. A replenishment toner as claimed in claim 1,
wherein a median particle diameter of the replenishment toner is equal to a median particle diameter of the initial toner.
